(19) United States
(12) Patent Application Publication
(10) Pub. No.: US 2020/0334274 A1
(43) Pub. Date: Oct. 22, 2020

(54) QUICK DATA STRUCTURING COMPUTING SYSTEM AND RELATED METHODS

(71) Applicants: Suresh JOSHI, Mississauga (CA); Chetan Manjinder PHULL, Brampton (CA)

(72) Inventors: Suresh JOSHI, Mississauga (CA); Chetan Manjinder PHULL, Brampton (CA)

(21) Appl. No.: 16/850,291

(22) Filed: Apr. 16, 2020

Related U.S. Application Data
(60) Provisional application No. 62/834,735, filed on Apr. 16, 2019.

(51) Int. Cl. G06F 16/26; G06F 16/248; G06F 16/16; G06F 9/54

(52) U.S. Cl. CPC G06F 16/26; G06F 9/54; G06F 16/168; G06F 16/248

(57) ABSTRACT

A quick data structuring (QDS) system is provided to obtain and store structured data in constrained computing environment, such as a content editor application. The QDS system includes a presentation layer for receiving user inputted structured data, a logic layer, and a database for storing the structured data. The presentation layer is displayable in a web browser, which is also displayable within the user interface of the content editor application. The logic layer obtains the structured data from the database and outputs the same to a report file, which is the visible portion of a document file, and that is editable in the user interface of the content editor application. The report file and the presentation layer can be simultaneously displayed in the content editor application.

### CROSS-REFERENCE TO RELATED APPLICATION

This application claims priority to U.S. Patent Application No. 62/834,735 filed on Apr. 16, 2019 and titled “Quick Data Structuring Computing System and Related Methods”, the entire contents of which are herein incorporated by reference.

### TECHNICAL FIELD

The following generally relates to quickly structuring data using a computing system. In a further aspect, a quick data structuring database is embedded in a content editor.

### DESCRIPTION OF THE RELATED ART

Data volume is growing. There is also growing difficulty to categorize and understand the data. The growing volume and the different sources of data also make it difficult to interpret and understand the data in order to gain insights from the data on an ongoing basis, as the data pool continues to grow.

Understanding unstructured data is particularly challenging. For example, text documents, graphs, images, videos, and audio recordings are some of the types of unstructured data. Some of the data is not in a digital format and, instead, is in an analog format. For example, text documents include physical paper documents and images could be physical photographs.

In order to ascribe meaning and insight to the data, a person reviews the data and adds their comments. This can be a time-consuming process. Furthermore, keeping a record of commentary in relation to the data in a structured manner is challenging when operating in constrained computing environments. For example, sensitive data may involve privacy-driven constraints or data fidelity aspects, or both. In some examples, an Internet connection is not available. It is herein recognized that relationships between commentary and portions of unstructured data can be difficult to maintain, as the unstructured data itself can be moved from one location (e.g. digital location or physical location, or both) to another. Transferring the unstructured data or the commentaries, or both, among different parties while operating in a constrained computing environment is also challenging.

These challenges of storing, sharing, and obtaining commentary data in relation to unstructured data occur in different industries, such as engineering, law, healthcare, insurance, media, and academia, to name a few.

### BRIEF DESCRIPTION OF THE DRAWINGS

Embodiments will now be described by way of example only with reference to the appended drawings wherein:

FIG. 1 is a schematic diagram of an example of a user device that has stored thereon a content editor and a quick data structuring system, according to an example embodiment.

FIG. 2A is a schematic diagram of multiple user devices each having quick data structuring systems and content editor applications, and being in data communication with a server system, according to an example embodiment.

FIG. 2B is a schematic diagram of multiple user devices, each having quick data structuring systems and content editor applications, transferring structured data between each other, according to an example embodiment.

FIG. 3A is a schematic diagram of data flowing between a quick data structuring system and a content editor application, according to an example embodiment.

FIG. 3B is a schematic diagram of data flowing between a quick data structuring system and a content editor application, and further being linked to other data files that have unstructured data, according to an example embodiment.

FIG. 4A is a schematic diagram showing sub-files of a document file, including one or more sub-files dedicated to a report file and one or more sub-files dedicated to the quick data structuring system.

FIG. 4B is a graphical user interface of a quick data structuring system operating within a graphical user interface of the content editor application, including a report file displayed in the graphical user interface of the content editor application, according to an example embodiment.

FIG. 5 is a schematic diagram of a database of the quick data structuring system, according to an example embodiment.

FIG. 6 is a schematic diagram showing components of a persistence layer, which is part of the database of the quick data structuring system, according to an example embodiment.

FIG. 7 is a schematic diagram showing components of a caching layer, which is part of the database of the quick data structuring system, according to an example embodiment.

FIG. 8 is a schematic diagram showing components of the security layer, which is part of the database of the quick data structuring system, according to an example embodiment.

FIG. 9 is a flow diagram of computer executable or processor implemented instructions for reading from the database of the quick data structuring system, according to an example embodiment.

FIG. 10 is a flow diagram of computer executable or processor implemented instructions for writing to the database of the quick data structuring system, according to an example embodiment.

FIG. 11 is a flow diagram of computer executable or processor implemented instructions for a garbage collection process to remove deleted content from the database of the quick data structuring system, according to an example embodiment.

FIG. 12 is a flow diagram of computer executable or processor implemented instructions for coordinating a data writing process between the quick data structuring system and the content editor, according to an example embodiment.

FIG. 13 is a flow diagram of computer executable or processor implemented instructions for coordinating a data deletion process between the quick data structuring system and the content editor, according to an example embodiment.

FIG. 14 is a flow diagram of computer executable or processor implemented instructions for coordinating a data validation process between the quick data structuring system and the content editor, according to an example embodiment.

FIG. 15 is a schematic diagram of a file daemon in data communication with the quick data structuring system and a file system, according to an example embodiment.

FIG. 16 is a schematic diagram of a file daemon having a local database, and the file daemon in data communication with a content editor and a file system, including, for example, a cloud database, according to an example embodiment.

FIG. 17 is a schematic diagram of a quick data structuring system that does not persistently store structured data in the environment of a content editor application, and instead persistently stores the structured data on a local database of a file daemon or on a remote database of a remote server.

FIG. 18 is a schematic diagram of a quick data structuring system that does not persistently store structured data in the environment of a content editor application, and instead persistently stores the structured data directly on a remote database of a remote server.

FIG. 19 shows another example embodiment of a document file comprising sub-files that store a database of a quick data structuring system, and the database does not have a persistence layer.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It is herein recognized that generating structured data from unstructured data, and storing the same, is difficult in constrained computing environments. For example, there are a set of different files that include unstructured data (e.g. a text document, a video file, an audio recording, an image, a graphic, etc.) and a first person wishes to add and separately store this commentary with respect to portions of these files. The first person creates a text document (e.g. a briefing document) and adds commentary to the text document, including a description of the related subject file and the specific location of a given portion of the subject file that is related to the commentary. For example, the subject file is a text document and the commentary from the first person is in relation to a specific sentence located in the text document. In another example, the subject file is a video and the commentary from the first person is in relation to a specific time range located in the video.

The first person, for example, shares the text document containing their commentary and a second person can add to the text document. The second person can change the text document, making additions and deletions, or can review the text document, or both. This can lead to problems of the first person and the second person not being sure whether they are using or viewing the most up-to-date version of the text document.

It is herein recognized that tracking the relationship between commentary and the respective relevant portion of the subject files is difficult. For example, descriptions of the subject files could be incorrect or misinterpreted.

It is further herein recognized that subject files can also be misplaced or difficult to find, or both.

It is also herein recognized that, in some environments, there is no Internet connectivity or there is limited Internet connectivity. In other words, data cannot be easily transferred over an Internet connection. Therefore, using a centralized database to track commentary can be difficult in these constrained connectivity environments. For example, some people work in indoor locations or in remote locations with limited or no Internet connectivity.

It is also herein recognized that data security in some situations is very important. For example, the data files or the commentary, or both, are preferably stored locally on a device or on a private server and network system, or a combination thereof. This complicates the coordination of data transfer, reading, writing, and deletion, among multiple user. In other words, in some situations, it is desirable to not use a cloud-based database to store commentary, in order to reduce the risk of a data breach or misuse of the commentary.

It is also herein recognized that there are different software systems that can be used to record commentary of people in relation to unstructured data. However, these software systems are often difficult to use from a user experience perspective. In another aspect, having multiple different software systems can be unwieldy and difficult from an Information Technology (IT) management perspective.

It is also herein recognized that capturing unstructured data in relation to physical items is also problematic. For example, there is unstructured data associated with physical items, such as paper documents, brochures, receipts, physical evidence (e.g. weapons, hair sample, clothing, devices, etc.) and physical objects (e.g. tools, machines, prototypes, products, etc.), and a person wishes to add commentary with respect to one or more aspects of a given physical item. The person creates a text document (e.g. a briefing document) and adds commentary to the text document, including a description of the related physical item and a specific attribute or feature of the physical item that is related to the commentary. Specific attributes or features include, for example, the location of the attribute or feature on the physical item. There is also unstructured data, including and not limited to commentary, that is related to people and places (e.g. locations). The issues associated with capturing, storing, viewing, and disseminating this unstructured data in a constrained computing environment are similar to those mentioned above for the example related to files that include unstructured data.

Therefore, a quick data structuring (QDS) system is herein provided to streamline the entry of structured data into a database, where the structured data is in relation to other types of data such as unstructured data.

In an example aspect, this entry of structured data can be performed manually by a person. In another example aspect, this entry of structured data is performed semi-automatically with the direction of a person and the automation of a computing system. In another example aspect, this entry of structured data is performed automatically by a computing system which automatically intakes data and populates a database of the QDS system.

In an example embodiment, the structured data includes commentary. In a further example aspect, the commentary includes insights of people in the course of their review of other files, documents, audio data, video data, images, physical items, people, places, etc. In an example aspect, the commentary is generated manually by a person. In another aspect, the commentary is generated by a person working in concert with the QDS system or another automated software system. In another aspect, the commentary is generated automatically by the QDS system or another automated software system.

In an example aspect, the QDS system is an add-in for a content editor application (e.g. Microsoft Word), which leverages and builds upon Application Programming Interfaces (APIs) (for example written in programming languages including, but not limited to, JavaScript) that are used to interface with the content editor and to facilitate streamlined data entry and summaries.

In an example aspect, web technologies (e.g. JavaScript, hypertext markup language (HTML), cascading style sheets (CSS)) are integrated via a browser inside a content editor application. As such, the QDS system can be integrated across different computing environments (e.g. Mac, Windows, Linux, Mobile, Web, etc.) by adhering to best practices for each platform's native web browsers. Examples of native web browsers include Internet Explorer or Edge on Windows, Safari on Mac, etc.

In another example aspect where the content editor application is Microsoft Word, the QDS system communicates with Microsoft Word (and the Microsoft Word document) via a set of Microsoft-supported APIs using a Microsoft-supported JavaScript library (“JavaScript API for Office” or “OfficeJS”).

In another example aspect, in the process of using the QDS system to summarize unstructured files into commentary (e.g. to create opinions), these arbitrary unstructured files (e.g. a free-text document) are converted into structured data, which includes metadata.

It will be appreciated that a document file includes one or more sub-files that represent a report file that is displayable via a graphical user interface (GUI) of the content editor application. For example, a document file having a .docx extension includes one or more sub-files that are XML files, which are used to represent a report file that is displayable in the GUI of Microsoft Word. It will also be appreciated that .docx document files and Microsoft Word are examples, and that other types of content editor applications and document files can be used according to the principles described herein.

In an example embodiment, the QDS system uses the structured data to populate a report file, which is the visible portion of a document file. In other words, the report file includes, for example, commentary, insights, facts (e.g. names, dates, locations, etc.), references to unstructured data, and other metadata, which are derived from or obtained from the structured data of the QDS system. In this embodiment, a user can review the report file to quickly and conveniently understand information about the unstructured data.

It will be appreciated that, in some example embodiments, it is not desirable for the structured data of the QDS system to be shown to the user via the visible portion of the document file (e.g. the report file), but it is desirable for the structured data to be retained and travel with the document file, so that another user can open up the same document file with the QDS system and see or manipulate (or both) the same data. As a result, in an example aspect, the structured data of the QDS system is stored somewhere other than the visible portion of the document file that the user typically interacts with. For example, the structured data is stored in sub-files of the same document file, and these sub-files that store the structured data are dedicated to the QDS system. In an example aspect, these sub-files that store the structured data, and which are hidden from the visible portion of the document file, are only accessible by the QDS system. In a further example aspect, the QDS system, via one or more APIs of the content editor application, uses these sub-files that store the structured data, in order to populate a report file (which is the visible portion of the same document file).

In an alternative example embodiment, the structured data is not retained in and does not travel with the document file. The QDS system persistently stores the structured data in a database that is separate from the document file. The QDS system then retrieves the structured data from this separate database and uses this retrieved data to temporarily populate sub-files that are part of a document file. In an example aspect, these sub-files in the document file are only accessible by the QDS system. In another example aspect, this same document file also includes a different set of sub-files that are used to generate the report file.

In an example embodiment, a content editor that does not have or that does not communicate with the QDS system is still able to read the report file. However, without the QDS system, the content editor cannot read the sub-files dedicated to the QDS system, nor can the content editor read the structured data stored in, or in association with, the QDS system.

Additional aspects of the QDS system are described below.

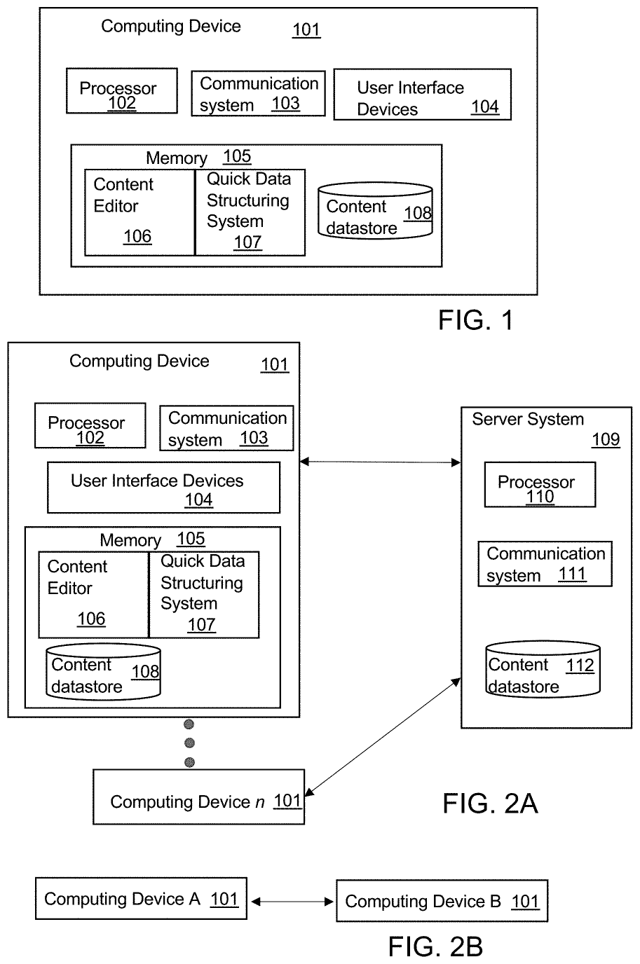

Turning to FIG. 1, an example embodiment of a computing device 101 is shown that a user interacts with to view and modify structured data, namely via the QDS system 107. The computing device includes a processor 102, a communication system 103, user interface devices 104 (e.g. display screen, keyboard, mouse or track pad, etc.) and memory 105. The memory has stored thereon a content editor 106, a QDS system 107 and a content datastore 108. It will be appreciated that memory 105 refers to devices that store data. In many computing devices, memory includes a persistent data storage device, also commonly referred to non-volatile memory or a non-transitory computer readable medium, or both. Examples of non-volatile memory devices include hard disk drives and solid state drives. Many computers also have volatile memory devices, such as random access memory and read-only memory. It will be appreciated that the content editor 106, the QDS system 107 and the content datastore 108 are stored in non-volatile memory, and can interact with volatile memory.

Examples of computing devices 101 include laptops, desktop computers, tablets, mobile devices, and personal digital assistants.

In an example embodiment, the QDS system 107 is integrated into the user interface of a content editor 106. The structured data, which includes commentary, is stored in a content datastore 108. The unstructured data files, to which the commentary relates, may also be stored in the content datastore.

It will be appreciated that the QDS system 107 is able to be executed on the computing device 101 without any access to a network, including and not limited to the Internet. In other words, the QDS system 107 is able to operate on a standalone computer. This is beneficial when Internet connectivity is poor or connectivity to a network is not possible. This is also beneficial to improve security, where sensitive data is (at times) desired to stay local to the given computing device on which it is stored.

Turning to FIG. 2A, in another example embodiment, multiple computing devices 101 having the content editor, QDS system and content datastore, are in data communication with a server system 109. The server system 109 includes a processor 110, a communication system 111, and a content datastore 112. For example, the computing devices 101 can access structured data or unstructured data, or both, via the content datastore 112 on the server system 112.

In an example embodiment, the computing devices 101 connect to the server system 109 over a local data network, which may be wired or wireless. In further example aspect, the local data network is a private data network. For example, companies or organizations may utilize private data networks in order to reduce security risks (e.g. data breaches, misappropriation of data, etc.).

In another example embodiment, the computing devices 101 connect to the server system 109 over the Internet. In yet a further aspect, the server system 109 is a cloud-based server system hosted by another cloud-based computing platform.

In another example embodiment, the computing devices 101 can transmit structured data to each other via the server system 109.

In another example embodiment, as per FIG. 2B, the computing devices A and B (101) transmit structured data to each other in a direct manner. This can be done, for example, over email, peer-to-peer sharing, or using a physical transfer medium (e.g. a memory stick, a data disc, etc.).

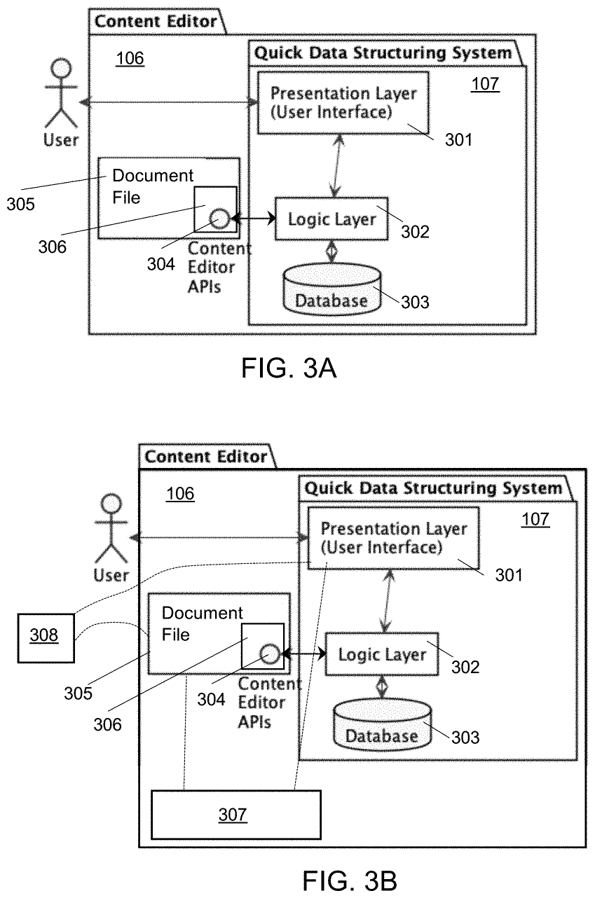

Turning to FIG. 3A, an example embodiment of a system architecture is shown including the content editor 106 and a QDS system 107 operating within the content editor application 106. In an example aspect, the QDS system 107 is considered an “add-in” into an existing content editor application 106 (e.g. Microsoft Word or some other content editor application). In an alternative example aspect, the QDS system 107 is native to a content editor application.

In an example aspect, the QDS system 107 operates in a web browser that uses web-based data formats and data structures, and this web browser is integrated into the content editor application 106. It will be appreciated that the QDS system 107 can operate in a web browser without being connected to the Internet.

The QDS system 107 includes a presentation layer 301 (e.g. the user interface) that interacts with the user, a logic layer 302 that includes data processing instructions and communication protocols with the content editor document 305, and a database 303 that stores the data.

The document file 305, for example, includes a report file 306 that shows the structured data, or portions of the structured data, or data derived from the structured data, or a combination thereof, in a format that is convenient for the user. For example, different report formats or report templates can be used to generate the report file 306. In this way, the report file 306 conveniently allows a user to review the structured data (e.g. commentary, references, metadata, etc.) that is with respect to unstructured data. In some industries, this report file 306 is called a briefing or a brief.

The logic layer 302 interacts with the report file 306 via one or more application programming interfaces (APIs) 304.

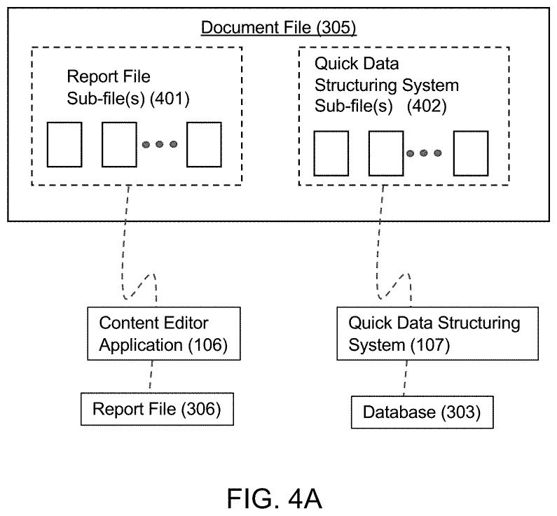

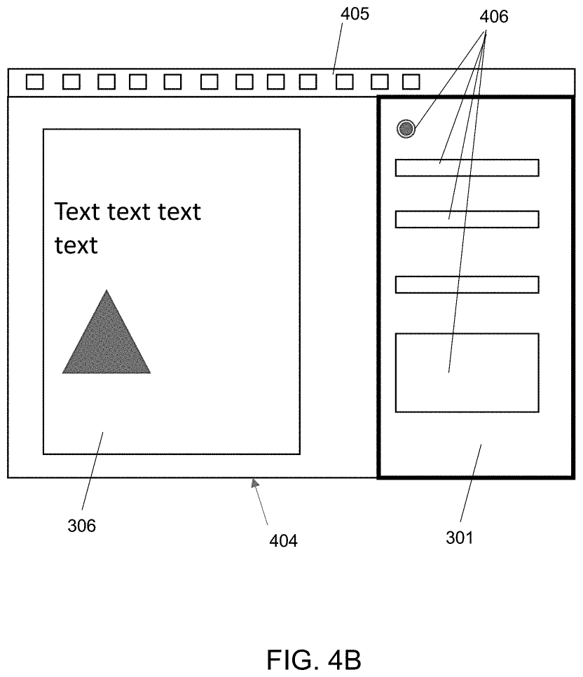

Turning to FIGS. 4A and 4B, an example embodiment of a document file 305 is shown in FIG. 4A and an example embodiment of a GUI 404 of the content editor application 106 is shown in FIG. 4B.

The document file 305 includes one or more sub-files 401 that are dedicated to the content editor application 106 and are used by the content editor application to generate a report file 306. The document file 305 further includes one or more sub-files 402 that are dedicated to the QDS system 107.

In an example embodiment, the one or more sub-files 402 form the database 303 of the QDS system. In other words, sending the document file 305 also means sending the structured data of the database 303.

In an example aspect, the one or more sub-files 401 dedicated to the content editor application include: a sub-file for the main body of the document, a sub-file for style settings, a sub-file for numbering, a sub-files for themes, a sub-file for a font table, a sub-file for the footnotes, a sub-file for the endnotes, and a sub-file for a footer. These sub-files are used to output the report file 306 shown in GUI 404 of the content editor application 106.

In another example aspect, there are multiple sub-files 402 dedicated to the QDS system store the structured data of the database 303, and these sub-files 402 include: a first sub-file for a first type of structured data, a second sub-file for a second type of structured data, and so forth. In other words, different types of structured data are respectively stored in different sub-files 402 that together form the database 303. In a further aspect of the embodiment having different sub-files storing different types of structured data, a given structured data entry of a first type in a first sub-file is linked or is marked as being related to a given structured data entry of a second type in a second sub-file. This creates relationships between the different types of structured data in the database. In another example aspect, the one or more sub-files 402 dedicated to the QDS system further include a sub-file for audit data. It will be appreciated that there may be other sub-files to store other data that are used by the QDS system.

In an example aspect, the sub-files 401 and 402 are in the format of readable by web browser applications. For example, one or more of the sub-files 401 and 402 are extensible markup language (XML) files. In another example, one or more of the sub-files 401 and 402 are XHTML files. In another example, one or more of the sub-files 401 and 402 are HTML files. In another example, one or more of the sub-files 401 and 402 are Open Office XML files (OOXML), in the context of a Microsoft Office computing environment. It will be appreciated that an OOXML file is herein considered to be a type of XML file. In another example, the sub-files 401 and 402 include a combination of different web-based markup languages.

In an example embodiment, all the sub-files 401 and 402 are data compressed together to form a single document file. The data compression ratio can be positive, zero, or negative.

In a particular example embodiment, the document file has a .docx file extension and the sub-files 401 and 402 are all XML files. In another example embodiment, future-known Microsoft Word files or other types of document files also having sub-files that are readable in a web browser can also be used in the QDS system.

As shown in the example of FIG. 4B, the content editor application 106 and the QDS system 107 operate together to access a document file 305 in order to display the report file 306 in the GUI 404 of the content editor application and to display the presentation layer 301 of the QDS system 107. In this example, the presentation layer 301 and the report file 306 are displayed at the same time. In another example, the presentation layer 301 and the report file 306 are displayed at different times.

The GUI 404 includes a tool bar 405 that includes different controls to modify layout, formatting and content in a report file 306. In this example, the presentation layer 301 of the QDS system 107 is visible in the GUI 404 of the content editor application 106. In an alternative example, the presentation layer 301 is shown separately from the GUI 404. In an example embodiment, the presentation layer 301 includes different types of user interface controls (e.g. buttons, check boxes, radial buttons, sliders, etc.) and data input fields 406.

In an example embodiment, a user enters in data into the QDS system 107, via the presentation layer 301. The data entered into the presentation layer 301 is structured by the QDS system, and this structured data in used to write to the database 303 and to the report file 306 via the one or more APIs 304. In other words, commentary that is entered into the presentation layer 301 is stored in the database 303. A portion or all of that same commentary is written and displayed in the report file 306. The resulting document 305 includes a report file 306 that can be further edited within the content editor application 106.

In another example aspect, in response to detecting a user's selection of content in the report file 306 in the GUI 404 of the content editor application 106, the QDS system 107 will automatically cause the structured data that corresponds to the selected content to be displayed in the presentation layer 301. In another example aspect, in response to detecting a user's selection of structured data in the presentation layer 301, the QDS system 107 automatically highlights or visually identifies certain content in the report file 306 displayed in the GUI 404, whereby this certain content in the report file corresponds to structured data selected in the presentation layer 301. These are some examples in which the display of the structured data is synchronized between the report file 306 of the content editor application and the presentation layer 301 of the QDS system. In a further example aspect, the structured data in the presentation layer is displayed according to a first data format and the same structured data in the document 305 is displayed according to a second data format.

In another example aspect, the structured data shown in the report file 306 and that is derived from or obtained from the database 303, or both, cannot be edited by a user through the report file 306. In this way, the structured data that forms part of the report file 306 cannot be mistakenly modified, or the structure of the structured data cannot be changed, or both. Instead, edits to the structured data, which is stored in the database 303, are made through the user interface in the presentation layer 301, and these changes are then propagated to the report file 306. This helps to maintain data integrity and the structure of the data.

In another example aspect, a user can use the GUI 404 to add ancillary data directly to the report file 306, and this ancillary data will be saved in the report file 306 as part of the document file 305. This ancillary data, for example, is not structured data and is not saved in the database 303 of the QDS system 107. In other words, in an example embodiment, a report file 306 is able to be populated with structured data derived from or obtained from the database 303, and is further able to be populated with ancillary data directly through the GUI 404 of the content editor application 106.

In an example embodiment, a report file 306 includes structured data derived from or obtained from the database 303, or both, and this same report file further includes ancillary data that has been directly inputted via the GUI 404 of the content editor application 106. In an example aspect, the structured data in the report file 306 is write and delete protected, so that a user cannot modify or delete the structured data shown in the report file 306 directly via the GUI 404. In another example aspect, the ancillary data in the report file 306 is modifiable and can be deleted directly via the GUI 404.

In an alternative example embodiment, changes in the report file 306 to the structured data are propagated via the APIs to the database 303, and in turn those changes appear in the presentation layer 301.

It will be appreciated that various rules and algorithms can be applied to the logic layer to suit different applications. For example, in an application related to law, the organization and display of the structured data is specific to legal practices. In another example application related to engineering, the organization and display of the structured data is specific to engineering practices. In another example application related to healthcare, the organization and display of the structured data is specific to medical practices.

Turning to FIG. 3B, another example embodiment is shown which is similar to the example embodiment shown in FIG. 3A. In FIG. 3B, unstructured data files can be accessed by selecting a data link in the presentation layer 301 or in the report file 306. For example, there is structured data (e.g. commentary, insight, metadata) displayed in the presentation layer 301 and the report file 306, and this structured data is related to an ancillary document 307 that includes unstructured data. By selecting a data link, which is a form of structured data, in the presentation layer 301 or in the report file 306, the ancillary document 307 having the unstructured data also is displayed in the GUI of the content editor 106. In this way, the user can conveniently view the commentary and the related ancillary document 307.

In another example, the structured data is related to a different type of unstructured data file 308. For example, the unstructured data is in the form of video, or an audio recording, or an image. After the computing device 101 detects selection of a data link in the presentation layer 301 or the report file 306, that related data file 308 is displayed in a different application specific to that format of the data file 308. For example, if the data file 308 is a video file, then a video player is launched playing that video file. For example, if the data file 308 is an image, then an image view is launched to display the image. In this way, the user can conveniently view the commentary and the related data file 308.

In an example embodiment in which the content editor application 106 is Microsoft Word, the document file 305 is a Microsoft Word document file (e.g. having the file extension .docx) that includes a set of sub-files 401 and 402, which are OOXML files. Typically, these OOXML files are stored by Microsoft Word as plain-text (neither obfuscated nor encrypted). In an example aspect, the QDS system encrypts or obfuscates, or both, one or more of these sub-files.

Here is a sample of a footnote stored as OOXML inside of a Word .docx file:

| | |
|---|---|
| <w:footnote w:id=“4”> | <w:p w:rsidR=“00CE5EB7” w:rsidRDefault=“00CE5EB7”> |

| | | | |
|---|---|---|---|
| <w:pPr> | <w:pStyle w:val=“FootnoteText”/> | </w:pPr> | <w:r> |

| | | |
|---|---|---|
| <w:rPr> | <w:rStyle w:val=“FootnoteReference”/> | </w:rPr> |

| | | | |
|---|---|---|---|
| <w:footnoteRef/> | </w:r> | <w:r> | <w:t>Footer for footnote 2</w:t> |

| | |
|---|---|
| </w:r> | </w:p></w:footnote> |

In an example aspect, the QDS system leverages the Microsoft Word OfficeJS APIs in order to create and manipulate custom XML files to store data—hidden from the user's typical workflow (ie. interacting with the visible Word document herein more generally called the report file 306).

In an example aspect, the underlying, custom XML storage and the visible Word document are kept in sync by the QDS system. In a further example aspect, the QDS system accesses the visible Word document by using the same OfficeJS APIs as it does to access the custom XML files.

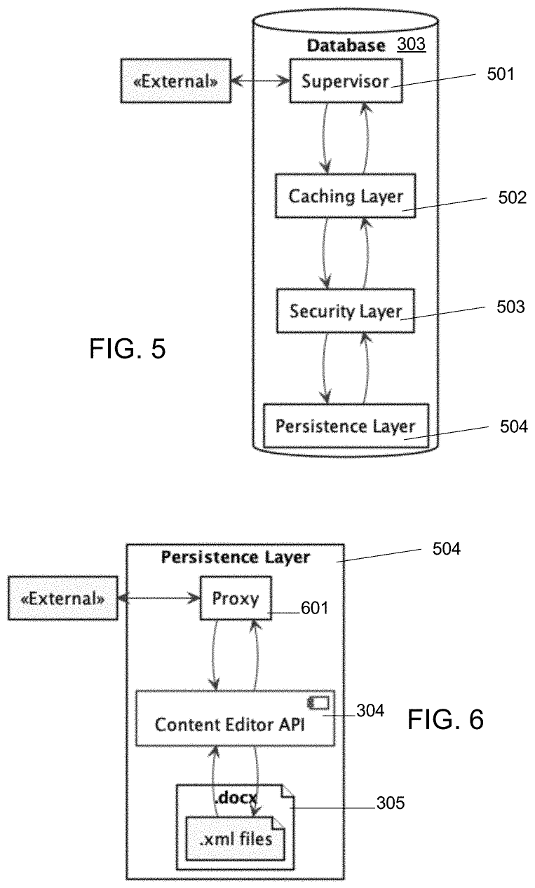

Turning to FIG. 5, example subcomponents of a database 303 of the QDS system 107 are shown. It will be appreciated that, in some examples, this database 303 resides within the computing environment of the content editor application 106 and that the structured data storable in a database 303 and also displayable in a report file 306 are linked together.

The database 303 includes the following subcomponents: a supervisor 501, a caching layer 502, a security layer 503, and a persistence layer 504.

The supervisor 501 includes executable instructions for determining the data interactions with anything external to the database 303, as well as maintaining the configuration and management of the database 303.

The caching layer 502 is a plain-text, in-memory representation of the persistent storage 504. It is used to increase performance of the system.

The security layer 503 is responsible for any of the obfuscation computations or encryption operations, or both, to/from the storage. This layer is configured by the supervisor 501 at the launch of the QDS system. In some other embodiments, there is no security layer in the database.

The persistence layer 504 is used to index, store and perform read, write, delete operations for the structured data in the database. In an example aspect, this includes managing the file input/output (typically through the API 304).

In an example operation, a data operation in the database 303 includes first sending the request through the supervisor 501, which transmits the request to the caching layer 502. Optionally, a security operation takes place by the security layer 503. Then the request is executed by the persistence layer 504. The results of the request are then transmitted back to the security layer 503 (or directly to the caching layer 502), then to the caching layer 502, and then to the supervisor 501 to output the result to the requesting component (e.g. the logic layer 302).

Below are two sample data flows (read and write) illustrating how all database layers operate together.

Turning to FIG. 6, an example embodiment of a persistence layer 504 is provided, which includes a proxy 601, a content editor API 304, and the document file itself 305, which include sub-files. The proxy 601 interacts with the content editor API 304 to make changes to the document file 305 and its sub-files that store the structured data. As noted above, in an example embodiment, the document file is a .docx file that includes multiple sub-files that are XML files.

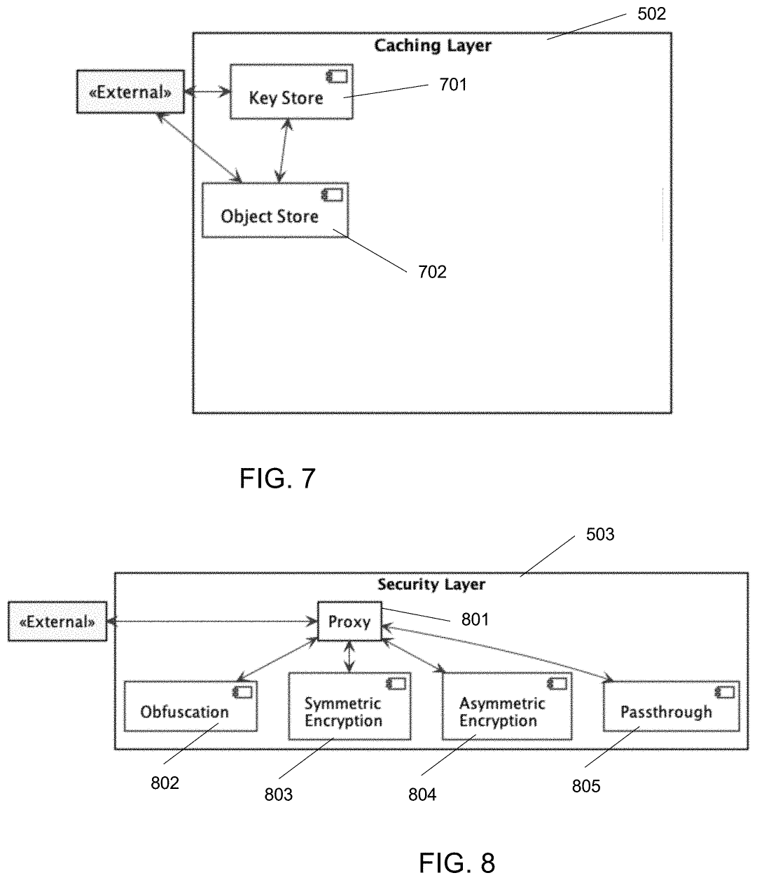

Turning to FIG. 7, an example embodiment of a caching layer is shown, which includes a key store 701 that interacts with an object store 702. The key store 701 stores memory representations of keys (e.g. object identifiers) that are stored in the persistence layer 504. The object store 702 stores last-recently-used (LRU) memory representations of some objects stored in the persistence layer. In an example aspect, the QDS system stores as many LRU memory representations of as many objects that can fit in the allocated memory of the computing device.

FIG. 8 shows an example embodiment of a security layer 503. Database requests pass through a proxy 801, and the proxy selects one or more security protocols to execute before a database request is transmitted to the persistence layer. Examples of security protocols include: obfuscation 802, symmetric encryption 803, asymmetric encryption 804, and passthrough 805.

In an example aspect, all the data stored in the document file 305 is visible as plain-text in either a web browser (e.g. as the Microsoft Word add-in ecosystem is based off of web browsers) or by uncompressing the document file 305 to expose all the underlying XML files (e.g. OOXML files).

As a result, it is herein recognized that it would be a security risk to store any authentication/authorization code in the document file 305—as it would be immediately available to anyone who has a copy of (or any access to) the document file 305.

Additionally, in some cases, it is desirable for the QDS system to generate data that may need to be persisted (e.g. stored locally), but that is not be accessible to everyone who might have access to the document file 305.

In traditional software applications, information like this is stored remotely in cloud servers and is protected by each user's access role and permissions (e.g. username and password, or other identifiers).

In the QDS system, data is stored in the web browser's cache (e.g. as a cookie, or other web storage) or in the document file 305, or both. Storing anything in the web browser can be sufficient in the use case of a single user working with the data. In another example aspect, if different users require access to the data, then the data is stored securely in the document file 305.

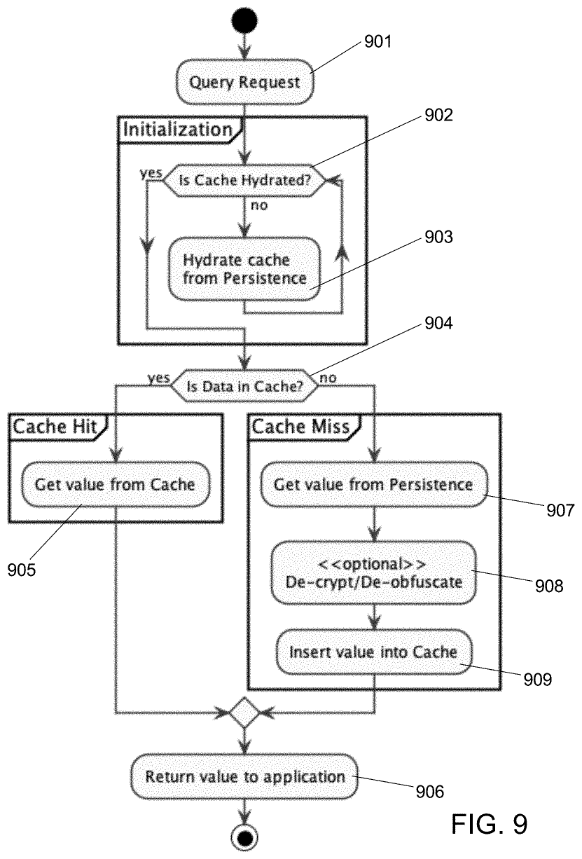

Turning to FIG. 9, example executable instructions are provided for reading from the database 303. A query request 901 is received by the database 303.

In an initialization process, at block 902, the database 303 determines if the caching layer 502 is hydrated (e.g. populated with data from the persistence layer 504). If so, the process continues to block 904. If the caching layer 502 is not hydrated, then the database 303 hydrates the cache layer 502 with data from the persistence layer 504 (block 903).

At block 904, the database determines if the requested data (from the query 901) is in the caching layer 502.

If so, the result is a cache hit, and the found data is retrieved from the caching layer 502 (block 905). This found data is then returned (e.g. outputted), as per block 906.

If the requested data is not in the caching layer 502, then this is considered a cache miss. At block 907, the database retrieves the requested data from the persistence layer 503. At block 908, the database decrypts or de-obfuscates the requested data, if the requested data has been encrypted or obfuscated. At block 909, the retrieved requested data is inserted into the caching layer 502. The retrieved data is then returned as per block 906.

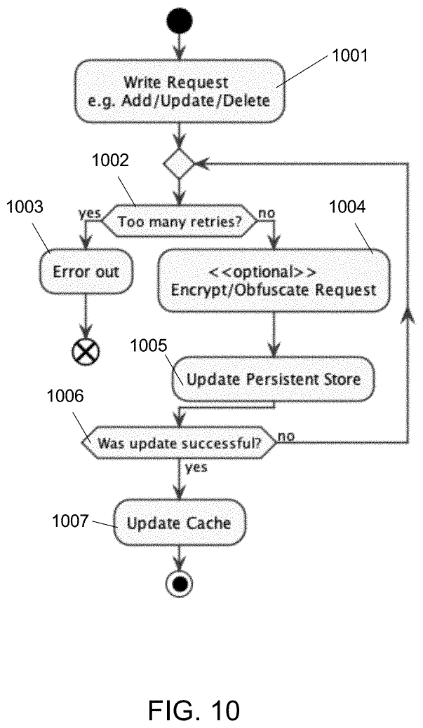

Turning to FIG. 10, example executable instructions are provided for writing to the database 303. A write request 1001 (e.g. a request to add, update, or delete, or a combination thereof) is received by the database 303.

At block 1002, the database 303 counts the number of retry attempts to fulfill this write request and determines if it is above a certain threshold. If the number of retries is above the certain threshold, then the writing process to the database 303 is marked an error (block 1003) and the process stops.

Otherwise, if the number of retries is below the certain threshold, then the process continues to block 1004 to encrypt or obfuscate the write request, or both. It is appreciated that, in some example embodiments, there are no encryption or obfuscation measures taken. The database 303 then updates the data in the persistence layer 504 according to the write request (block 1005). The database 303 performs a check to see if the update is successful (block 1006) and, if so, the database 303 then updates the caching layer 502 (block 1007) to reflect the update made to the persistence layer 503.

If the update was not successful, then the process from block 1006 returns to block 1002 to determine if the write process can be retried.

It is herein recognized that in most data writing operations, data is written first to the cache since this is fastest. Then data from the cache is used to update the persistent data store. However, this could lead to inconsistencies between the cache and the persistent data store.

By contrast to the cache-first data systems, in the QDS system, data is first written to the persistence layer and then the caching layer uses the update made to the persistence layer to make the update to the caching layer. This ensures consistency in the data. For example, many applications and industries desire consistency of data over speed of data operations.

In the QDS system, the read operations from the database are based on reading data from the caching layer, which occurs after verifying that the caching layer has data representing the data stored in the persistence layer. This ensures consistency of data based off the data in the persistence layer.

In an example embodiment, data is inputted into the presentation layer 301 of the QDS system to trigger a write request to the database 303. This inputted data is automatically processed as structured data and is displayed in the report file 306. As part of this data writing process, the data update is made at the persistence layer 504 of the database first. The caching layer 502 of the database is then updated to reflect the update made in the persistence layer. A read operation from the caching layer 502 is made via an API 304 to update the display of data in the document 305. In this way, the data inputted in the presentation layer 301 and the data displayed in the report file 306 correspond to each other.

In a further example aspect, the data inputted into the presentation layer 301 is passed to the logic layer 302, and the logic layer then provides the inputted data to the supervisor 501 of the database 303. The supervisor transmits the inputted data to the persistence layer for storage. The inputted data is then put into the caching layer 502. The logic layer then makes a read request, via the supervisor, to read the inputted data from the caching layer. The logic layer then consumes this inputted data and pushes it to the report file 306 via the API.

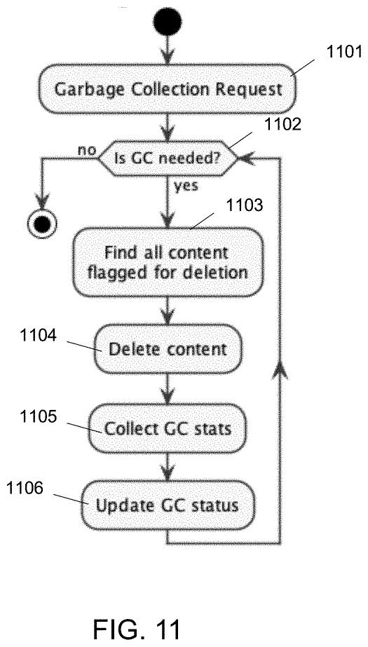

Turning to FIG. 11, example executable instructions are provided for garbage collection. This process is used to delete data that has been marked for deletion.

In an example aspect of the QDS system, when a user or a software module marks data for deletion, the data in the database 303 is not immediately deleted. Instead, after some time has passed, or after some additional action (e.g. a further user request for garbage collection, or some one or more conditions are satisfied, or both), then the data is permanently deleted from the database 303. This time delay or further action allows a user or another software module to reverse the data deletion process. This is desirable since data deletions can be accidental. Accordingly, the garbage collection process, which permanently deletes the data from the database 303, occurs at a later time.

In an alternative example, data that has been marked for deletion is automatically and immediately deleted from the database. In other words, the garbage collection process is executed immediately.

In FIG. 11, the database receives a garbage collection request 1101 and determines if the garbage collection process is needed (block 1102). If it is not needed at that time, the process is stopped. However, if the garbage collection process is needed, then the database identifies all the data in the persistence layer that has been marked for deletion (block 1103). At block 1104, this marked data is deleted from the persistence layer and then accordingly from the caching layer. At block 1105, the database collects statistics about the garbage collection process and then updates the garbage collection status (block 1106). This information is fed back to the decision-making process at block 1102 to later determine subsequent garbage collection processes.

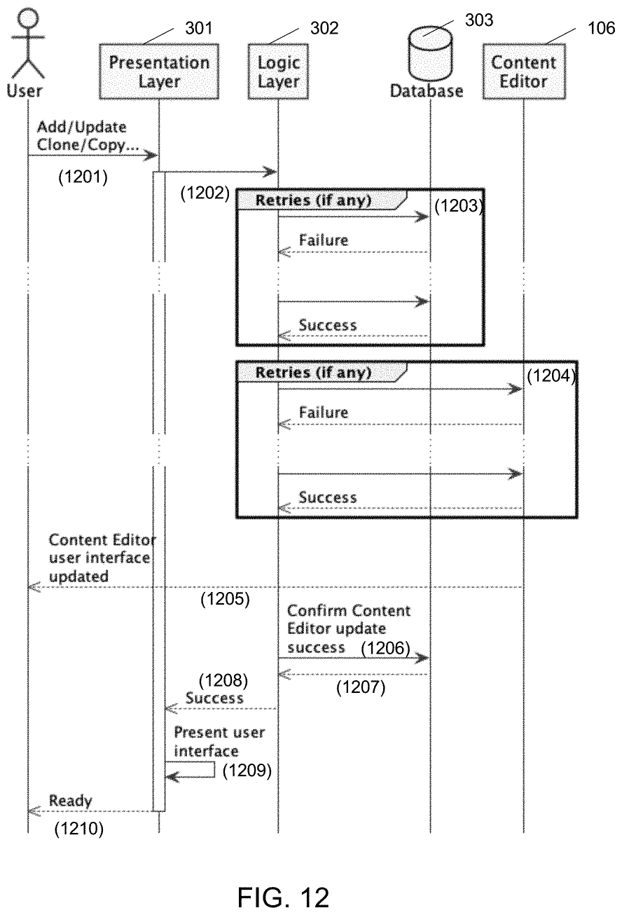

Turning to FIG. 12, an example of executable instructions is provided for writing data to the database.

Operation 1201: The presentation layer receives a user input to add/update/clone/copy data.

Operation 1202: A write request based on the user input is sent from the presentation layer to the logic layer.

Operation 1203: One or more attempts are made by the logic layer to complete the write request to the database. If the process fails, then the process stops here. If the write request process is a success, the process continues to operation 1204.

Operation 1204: After the write request has been successfully made to the database, then the logic layer initiates the same write request of data to the report file 306 in the content editor application 106. If the process fails, then the process stops here. If the write request at the content editor application 106 is a success, the process continues to operation 1205.

Operation 1205: The content editor user interface is updated with the successful write request, which is also displayed to the user.

Operations 1206 and 1207: The logic layer confirms with the database that the content editor update is a success, and the database provides a response indicating the success.

Operation 1208: The logic layer transmits the success confirmation to the presentation layer.

Operation 1209: This success confirmation is indicated in the presentation layer.

In an example embodiment, the success confirmation is indicated using a pop-up GUI element, or a toast GUI element, or some other transient user interface image, text or audio element, or a combination thereof. It will be appreciated that other ways to indicate success confirmation are applicable to the principles described herein.

Operation 1210: The presentation layer is ready to receive additional user input from the user.

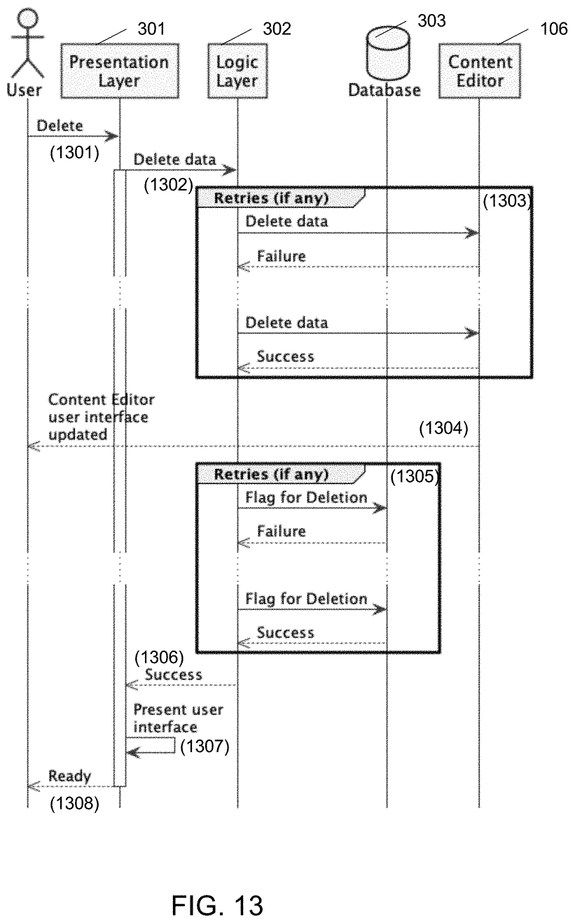

FIG. 13 shows example executable instructions for data deletion.

Operation 1301: The presentation layer receives a user input to delete data.

Operation 1302: A delete request based on the user input is sent from the presentation layer to the logic layer.

Operation 1303: One or more attempts are made by the logic layer to complete the delete request at the content editor application. If the process fails, then the process stops here. If the delete request process is a success, the process continues to operation 1304.

Operation 1304: The content editor application updates its user interface (e.g. the report file 306) to show that the subject data is deleted.

Operation 1305: After the delete request has been successfully made at the content editor application, then the logic layer initiates the same delete request of data to the database. If the process fails, then the process stops here. If the delete request at the database is a success, the process continues to operation 1306.

Operation 1306: The logic layer transmits the success confirmation to the presentation layer.

Operation 1307: This success confirmation is indicated in the presentation layer.

Operation 1308: The presentation layer is ready to receive additional user input from the user.

In an example aspect, the data is deleted first from the report file 306 in the content editor application 106 and then from the database 303. In this approach, the user will more quickly receive feedback that the deletion has been successfully completed, or not. If the deletion has been successfully completed visually on the report file 306, then the user will not try to further delete data. By contrast, if the data is deleted from the database 303 first and the user does not visually see that the data has been deleted from the report file 306 immediately, they may try to delete the data again, leading to complexity. Furthermore, if the content editor application crashes during a delete operation, or if the deletion was made by accident, then the data in the database 303 still remains. In other words, when deleting data, it is herein recognized that it beneficial to delete the data from the report file 303 first and then later delete the data from the database 303.

In an alternative example embodiment, the data is deleted first from the database 303 and then from the report file 306 in the content editor application.

It is herein recognized that, in some example embodiments, the content editor application's APIs introduce their own lags and latencies. In a non-limiting example, an API to a Microsoft Word document file access typically takes 100 ms, instead of <1 ms. Different computing hardware, different software versions and different content editors can affect the lag and latencies that are introduced by the APIs.

It is also herein recognized that, in another example aspect, deletion of data can be a dangerous computing operation, as removing information from either the database 303 (e.g. XML storage) or the report file 306 (e.g. the visible Microsoft Word document), but not both, will cause a user inconsistency.

It is also herein recognized that, in another example aspect, the underlying database (e.g. XML storage) and the report file 306 (e.g. the visible Microsoft Word document) are files—so they suffer from the need for File Input/Output (I/O); this is usually slow and unreliable when compared to memory access.

As a result of the above, it is desirable to validate the data between the database 303 and the data of visible report file 306 in the content editor application 106.

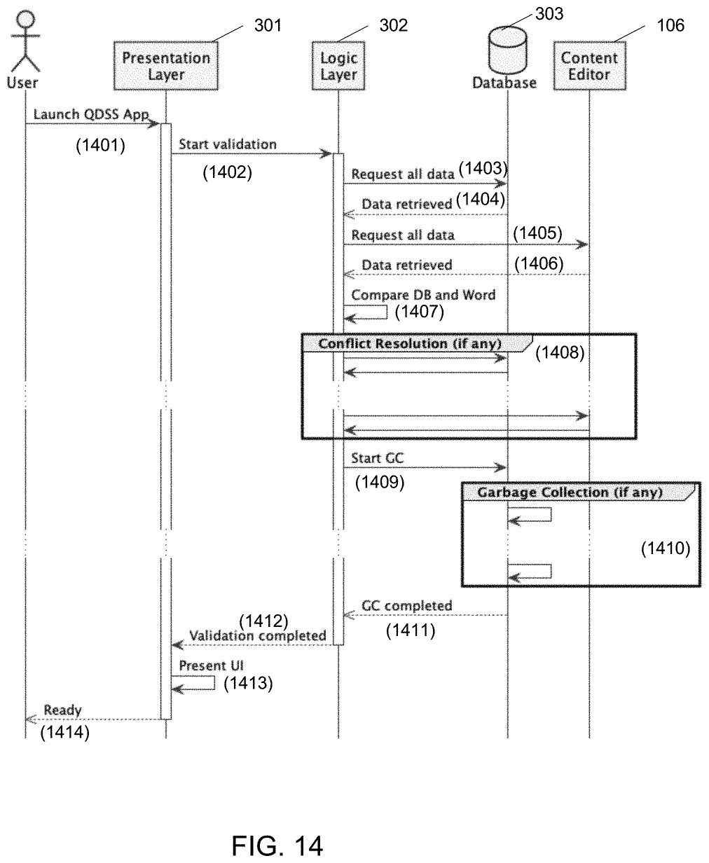

FIG. 14 shows executable instructions for validating the data.

Operation 1401: The QDS system is launched either automatically or based on user input, which leads to the display of the presentation layer.

Operation 1402: The validation process is initiated at the logic layer.

Operation 1403: The logic layer requests all data from the database.

Operation 1404: The database returns the data to the logic layer.

Operation 1405: The logic layer request all the data presented in the GUI of the content editor application (e.g. in the report file 306).

Operation 1406: In response, the content editor application returns the data (e.g. the data populated in the report file 306).

Operation 1407: The logic layers compares the data obtained from the database with the data obtained from the content editor application. If there are discrepancies in the comparisons, then the process continues to operation 1408. On the other hand, if there are no discrepancies and the data matches, then the process continues to operation 1409.

Operation 1408: In the case where there is data discrepancy, the logic layer provides a write operation to the database or to the content editor application, to ensure that the data matches. In an example embodiment, the data in the database is considered to be accurate, and so a write or delete action is made to the data in the content editor application so that the data in the content editor application matches the data in the database.

Operation 1409: The logic layer initiates a garbage collection process at the database.

Operation 1410: The database executes a garbage collection process, which could lead to the deletion of data from the database, or could lead to no deletion of data.

Operation 1411: The database notifies the logic layer that the garbage collection process has been completed.

Operation 1412: The logic layer then notifies the presentation layer that the data validation is complete.

Operation 1413: The presentation layer then notifies the user that the data has been validated.

Operation 1414: The presentation layer is ready to receive additional input from the user.

In another example embodiment, the validation process is initiated due to detecting another event. For example, the validation process is initiated after detecting a data writing operation or a data deletion operation, or both.

It is herein recognized that using the underlying XML storage with the Microsoft Word APIs presents some limitations. For example, while opening a single XML storage file is “fast”, opening multiple XML storage files takes proportionally long. Additionally, file I/O can add reliability problems. Further, data corruption is dangerous, and, in some cases, there is no built-in way to recover data.

More generally, having a single sub-file dedicated to the QDS system with all the structured data is very fast, but has high risk. Whereas, having a separate sub-file dedicated to the QDS system for every piece of structured data is slow, but is safe. Therefore, in an example aspect, the sub-files that form the database 303 are double buffered. In an alternative example, writing to sub-files that form the database 303 is executed in a continuous addition manner.

In the example of the double buffer approach, some number of files (n) are decided upon for the performance vs safety tradeoff mentioned above. Each file has a duplicate, so there are 2*n number of files. Writes are alternated between each duplicate and then verified to ensure data was written safely. If the write succeeds, then the duplicate is updated (either immediately, or “eventually”). If a write fails (or a file is/becomes corrupted), then the duplicate guarantees a roll-back option, where a maximum of 1 operation is missed. In a further example aspect, the same logic applies for deleting information from files. A delete is applied, and in the event of a failure or corruption—the backup is used.

In the ‘continuous addition’ manner of writing data, there is not a fixed number of backups, but rather files are created on-demand (or as-needed). When new data is to be written, a file just containing the ‘cliff’ is created, which includes a listing of the changes between a previous file version and the most current file version. Alternatively, when new data is to be written, an entirely new file will all the previous file's contents (including the new contents) is created. Deletions occur by flagging a file or content for deletion—rather than actually performing a destructive operation. Periodically, a “garbage collection” occurs—where all non-current files and data is deleted.

Intuitively, re-creating full files all the time seems slow. However, as the time to open a file is 10-100× the time required to write to the file—the incremental time is negligible.

An additional benefit is that changes can be rolled back as far as the last ‘garbage collection’.

In an example embodiment, garbage collection occurs at the launch of the QDS system, at the close of the QDS system, or when the QDS system is idle (e.g. not in use), or a combination thereof. It will be appreciated that the garbage collection process can occur at different times.

In an example embodiment, current web browser technology has built-in access restrictions so that the web browser, or a system operating within a web browser, cannot automatically access file systems on the computer or cannot automatically access file systems on a data network to which the computer is connected, or both. In another aspect, the web standard HTML5, and other HTML standards, also restrict this type of file access. Accordingly, in an example embodiment using current web browser standards, the QDS system, which operates as a web browser, does not have automatic access to the user's file system.

In an example embodiment, an application residing on the computer device is provided to bridge between the QDS system and the user's file system. This application has access to the user's file system stored on the computer device, or a file system on a data network to which the computer is connected, or both. In an example aspect, the application includes a web server to facilitate the data bridge between the QDS system and the file system. The application is herein referred to as a file daemon. In other words, using the file daemon, in an example embodiment, the QDS system is able to access data files that include unstructured data (e.g. images, other documents, video files, audio files, etc.). In another example embodiment, the QDS system is able to access different document files 305 (e.g. briefings or reports) that include the structured data that is readable by the QDS system 107.

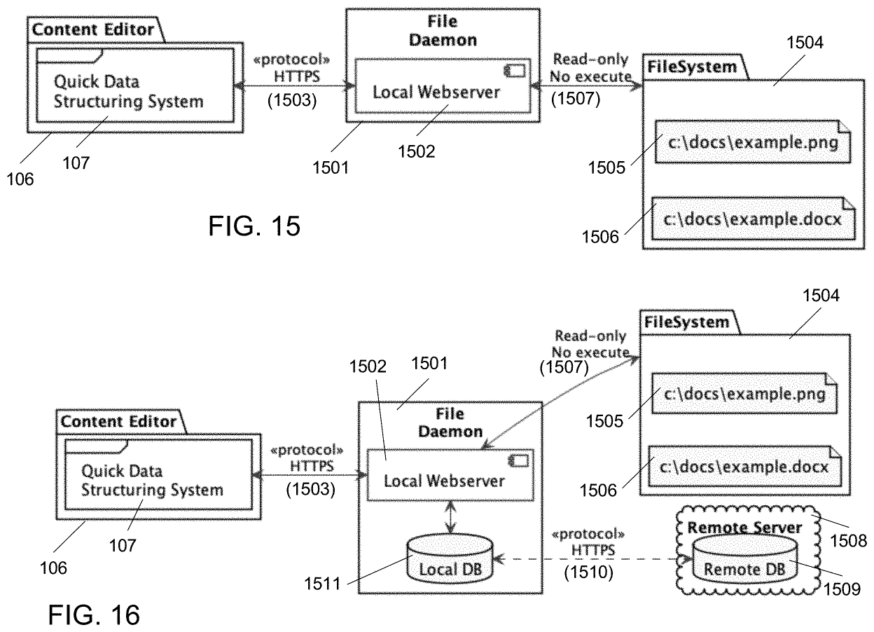

Turning to FIG. 15, the content editor 106 and the QDS system 107 are shown in data communication with the file daemon 1501, and the file daemon 1501 in turn is in data communication with the file system 1504 that stores example files 1505, 1506. The file daemon includes the local webserver 1502.

In an example aspect, a web-based communication protocol 1503 is used between the QDS system 107 and the local webserver 1502. For example, the communication protocol 1503 is hypertext transfer protocol secure (HTTPS).

In another example aspect, the local webserver 1502 communicates with the file system 1504 via a read-only access (1507).

The webserver 1502 interfaces with an API on a local port of the computer, which the QDS system can access and communicate across. In an example aspect, the API is encrypted by HTTPS.

Turning to FIG. 16, in an alternative example embodiment, a remote server 1508 (e.g. on a local data network or on a cloud server) holds a remote database 1509 for other files. The file daemon 1501 further includes a local database 1511 which is in data communication with the local webserver 1502. The local database 1511 of the file daemon also has a web-based communication link 1510 to the remote server 1508 to access and retrieve data from the remote database 1509. In an example embodiment, the communication link 1510 uses the HTTPS protocol.

This example embodiment in FIG. 16 can be used to store structured data in the file daemon's local database 1511, in alternative to or in addition to storing the structured data in sub-files database (e.g. XML files) in the document file 305. In an example embodiment, the structured data is not stored in the sub-files database of the document file 305 and, instead, the structured data is stored in the file daemon's local database 1511. The structured data stored in the file daemon's local database 1511 can also be transmitted to the remote database 1509 for backup storage or for further data processing (e.g. data analytics), or both. In an example aspect, the QDS system performs real-time, two-way sync with the file daemon to read, write, and delete the structured data stored in the file daemon's local database 1511. In another example aspect, immediately (if online), or eventually (if offline), the file daemon performs two-way sync with the remote server's database 1509. This syncing can be done as needed, on-demand, or lazily. In another example aspect, this data workflow allows for a fully-offline system, with almost all the benefits of a fully-online system.

Below are example security aspects in relation to file daemon embodiments. One or more of these aspects may be applied.

In an example aspect, access to the open port is restricted to the user's computing device (and not exposed outside of the computer to the network).

In another example aspect, all data is transferred through an HTTPS pipe which internally connects the QDS system to a webserver 1502 that is local to the file daemon. In a further aspect, no readable plain text is ever transmitted.

In another example aspect, all data transmission occurs over HTTPS against an authorized certificate.

In another example aspect, the file daemon only has read-only access to files and directories, no execution capabilities.

In another example aspect, only file metadata is ever transferred (e.g. name, date, size). In this way, there is no file content to obtain by adversarial parties.

In another example aspect, there is a secure “pairing” process between the file daemon and the QDS system that ensures malicious plugins do not have access.

In another example aspect, data is additionally obfuscated or encrypted, or both, inside the HTTPS data pipe.

Below are some example embodiments for a pairing process between the file daemon and the QDS system, which can be used to establish the secure communication link therebetween.

In an example embodiment, the QDS system and the file daemon engage in port agreement. In particular, the local port that the webserver selects is not static, and instead it jumps around based on a pre-planned algorithm that only the QDS system and the file daemon have. The file daemon does not reply to pings or port knocking. In other words, only the QDS system will know where to look and how to execute the handshake for the pairing.

In another example embodiment, the QDS system and the file daemon are paired using manual port entry. The local webserver port is manually input into both the QDS system and the file daemon by the user. The file daemon does not reply to pings or port knocking, which means that only the QDS system knows the location of the local webserver port and how to handshake with it for the pairing.

In another example embodiment, the QDS system and the file daemon are paired using a trust on first use protocol. The QDS system and the file daemon are linked by the user. In order to re-link the QDS system and the file daemon, the existing file daemon needs to be uninstalled and re-installed. The file daemon creates a unique, random, complicated key (in a file, or output on the console) for one-time use (so that it cannot be read back out programmatically). The user must enter this key in the QDS system to link the QDS system and the file daemon.

In another example embodiment, the QDS system and the file daemon are paired by establishing trust via an in-band certificate. Pre-signed certificates are transmitted by a trusted entity to both the file daemon and the QDS system, which are then used to authenticate each side with the other.

In another example embodiment, the QDS system and the file daemon are paired using pre-shared keys. The file daemon and the QDS system are installed with pre-shared keys, which are later used to form a handshake and establish the pairing.

In another example embodiment, the QDS system and the file daemon are paired using symmetric keys. The user “logs on” to the file daemon. The file daemon then communicates with a remote server and gets a key (and configuration), which are stored locally on the file daemon. The user “logs on” to the QDS system, and the QDS system communicates with a remote server and gets a key (and the file daemon configuration). The QDS system stores these in a private section of the content editor application's storage (e.g. a private section of the Microsoft Word Add-in storage). The QDS system then searches for the file daemon and the two are paired using the server-obtained keys and configuration.

It will be appreciated that other approaches that can be used to pair the file daemon and the QDS system are applicable to the principles described herein.

In the above example embodiments, after the QDS system and the file daemon are paired, there are no further pairing attempts allowed by either side, until the user initiates a “reset” mechanism.

In another example aspect, after pairing, the data transmitted across the HTTPS pipe can be further encrypted. In a further aspect, this further encryption uses the pre-shared keys or the symmetric keys mentioned above.

It will be appreciated that, in an example embodiment, a user enters structured data into the QDS system via a GUI of the presentation layer 301, which include, for example, text input fields, radial buttons, check boxes and the like.

In another example, the QDS system or an ancillary data processing module automatically scrapes data from data files that have unstructured data, and automatically populates at least a portion of the structured data database 303 or the structured data database 1511 with structured data obtained or derived from the scraped data. The user then uses the presentation layer 301 to add new structured data, modify the automatically populated structured data, or to delete the automatically structured data, or a combination thereof. In another example embodiment, the QDS system or an ancillary data processing module automatically scrapes data from data files that have unstructured data, and automatically populates all the structured data database 303 or the structured data database 1511 with structured data obtained or derived from the scraped data.

For example, the data files containing unstructured data include text, and one or more of the following computations are used to scrape data from these data files: optical character recognition; natural language processing; sentence splitting; key word search; text classification; and term frequency-inverse document frequency (TF-IDF) scoring.

For example, the data files containing unstructured data include visual imagery (e.g. such as a video file and a picture), and one or more of the following computations are used to scrape data from these data files: pattern recognition; facial recognition; optical character recognition; object recognition; and location recognition.

For example, the data files containing unstructured data include audio data (e.g. such as a video file and an audio recording), and one or more of the following computations are used to scrape data from these data files: speech-to-text processing; voice recognition; and music recognition.

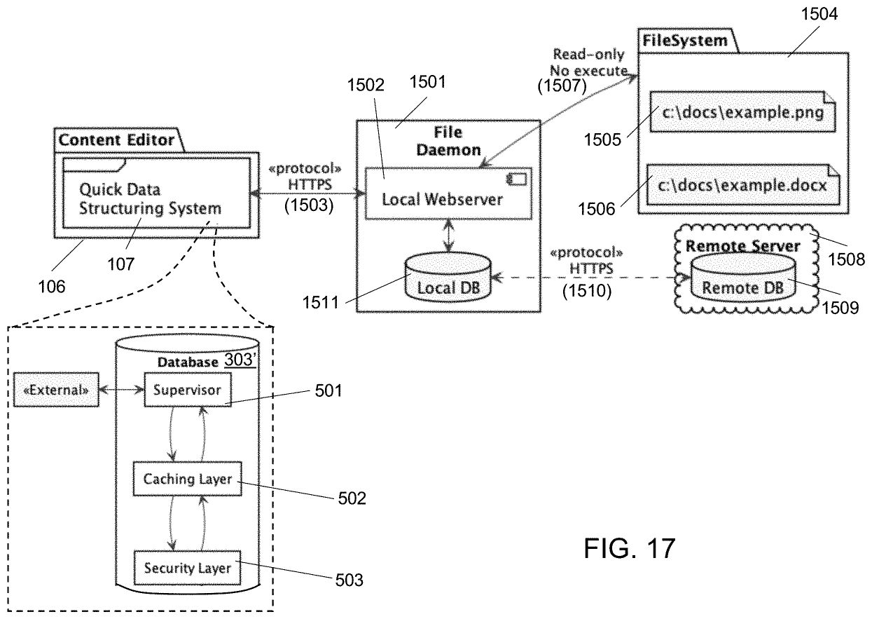

Turning to FIG. 17, another example embodiment is shown in which the QDS system 107 has a different embodiment of a database 303′. In particular, the database 303′ does not include a persistence layer that is stored locally in the add-in of the QDS system 107. In other words, the document file 305 does not persistently store the structured data of the QDS system 107. Instead, the structured data of the QDS system is persistently stored in the local database 1511 of the file daemon 1501, or is persistently stored in the remote database 1509 of the remote server 1508, or is persistently stored in both of these databases 1511 and 1509.

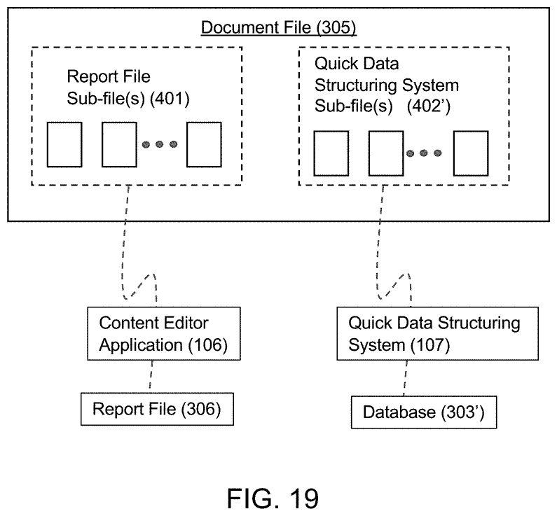

Turning briefly to FIG. 19, the document file 305 includes sub-files 402′ that are dedicated to the QDS system 107 and, in particular, are used to form the database 303′.

The database 303′, as shown in FIG. 17, includes a supervisor 501, a caching layer 502 and a security layer 503. In an example embodiment, the QDS system 107 obtains the structured data in the local database 1511 of the file daemon 1501 via the HTTPs pipeline 1503, or the QDS system 107 obtains the structured data from the remote database 1509 via the local database 1511 of the file daemon 1501. The QDS system 107 then uses this obtained structured data to populate the caching layer 502 in the database 303′. The QDS system 107 can then use a portion or all of the structured data stored in the caching layer 502 to populate the report file 403, for example, by writing to the sub-files 401 used to generate the report file 306.

In FIG. 17, the security layer 503 performs data security operations (e.g. decryption or deobfuscation, or both) prior to populating the caching layer 502 with the structured data from the database 1511 or 1509. In an example aspect, the security layer 503 performs data security operations (e.g. encryption or obfuscation, or both) prior to adding or modifying structured data in the database 1511 or 1509. In an example aspect, the security layer 503 secures data transmitted between the caching layer 502 and the database 1511 or 1509, which persistently stores the structured data or the QDS system 107.

In an example embodiment, one or more sub-files 402′ dedicated to the QDS system stay or persist with the document file 305.

In an alternative example embodiment, the document file 305 has no (or zero) sub-files 402′ that stay or persist with the document file 305. In another example embodiment, there are no sub-files 402′ that form part of the document file 305.

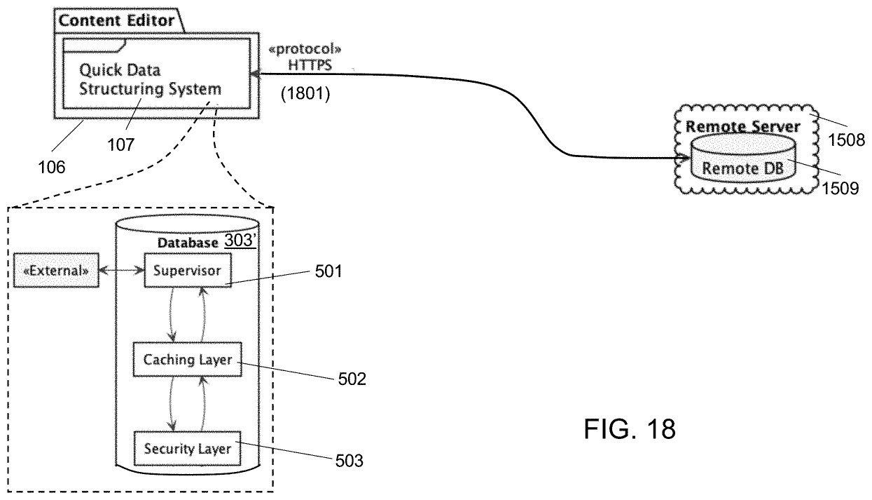

Turning to FIG. 18, this example embodiment is similar to FIG. 17. However, in the example embodiment of FIG. 18, there is no file daemon. Instead, the structured data is persistently stored on the remote database 1509 of the remote server 1508 (e.g. a cloud database), and the QDS system 107 directly obtains the structured data via an HTTPS pipeline 1801. In an example aspect, the security layer 503 performs data security operations (e.g. decryption or deobfuscation, or both) prior to populating the caching layer 502 with the structured data from the remote database 1509. In an example aspect, the security layer 503 performs data security operations (e.g. encryption or obfuscation, or both) prior to adding or modifying structured data in the remote database 1509. In an example aspect, the security later 503 secures data transmitted between the caching layer 502 and the remote database 1509, which persistently stores the structured data or the QDS system 107.

Example Embodiment for Using QDS System to Generate a Legal Briefing

It is appreciated that the QDS system can be applied to various different types of data and to various types of use-cases (e.g. engineering, construction, healthcare, academia, education, law, media, etc.). In an example application, the QDS system is used to quickly generate a legal briefing (e.g. a report file 306 for use in the legal industry) from structured data that is obtained or derived from unstructured data. By way of background, during the discovery phase of a legal proceeding, lawyers and law clerks review source material (e.g. documents, videos, audio recordings, physical evidence, etc.) and generate a briefing document that notes and retains important points. In a further example aspect, unstructured data includes depositions, interviews, testimony, facts, evidence, etc. and these can be in the form of text-based documents, pictures, audio recordings, videos, physical evidence, and other files. The QDS system described herein is used to significantly speed up this process and to provide a repository with high data fidelity, even while operating in a constrained computing environment.

In an example embodiment, the structured data includes one or more of: a name of a relevant document or a relevant file (herein called a production); the date of the production; the location of the production (which may include a data link to the production if the production is a digital file stored in a file system); a point, which is a fact supported by the production and which has relevance to a given issue at hand; the location of a given point within the production (which may include a data link to the specific location in the production if the production is a digital file); commentary from a user (e.g. a lawyer, law clerk, student-at-law, or other involved person) about a given point or a given collection of points; and hearsay content identified in a given production (which may include a point's location in a given production). The briefing report may include one or more of these types of structured data. The briefing report may also include other data, such as conclusions and insights, which are stored in the structured database 303, 1509, or 1511, or a combination thereof.

In an example embodiment, structured data can be automatically mined from various data sources and used to automatically populate some or more of the structured data fields in the database 303, 1509, or 1511, or a combination thereof.

For example, a set of documents that store unstructured data and that have been digitized or are already digital, are processed to automatically populate the database 303 or 1511, or both, with productions (e.g. the name of the production, the date, the author, etc.) and points found in the productions (e.g. text, tags, location in the production, etc.). This process includes a multi-stage data pipeline that assesses the relevance of the initial set of documents and then compiles a list of productions, which is a subset of the set of documents.

In the multi-stage data pipeline, the QDS system receives a user selection that identifies a type of legal assessment (e.g. tort litigation matter, etc.), which serves as a template for the type and nature of data that the data pipeline will mine from the set of documents.

An optical character recognition is applied for the imaged documents. In other words, the set of documents are pre-processed in the data pipeline, so that the text is computer machine readable. For each one of the documents in the data pipeline: a statistical natural language processing (NLP) model is applied to the given document (e.g. text is processed by a Tokenizer, a Sentence Splitter, a Parts of Speech tagger, a Parser, a Named Entity Recognizer, etc.); the given document is classified as a document type (e.g. classified as expert opinion evidence, factual direct evidence, report, receipt, picture, etc.) using, for example, a Supervised Classifier with pre-built atlas/corpus; the given document is classified by a legal metric (e.g. an adjustable metric that is weighted to the lawyer's use case) using TF-IDF and Google PageRank-like (or other Similarity metric) algorithms compared against existing literature; and the given document is then prioritized by relevance according to the input, such as type of legal assessment, document type, document content, and legal metric.

In an example aspect of the data pipeline, the user is presented with the list of prioritized relevant documents and the user selects which documents are productions. In other words, the user confirms the relevancy of the documents. In an alternative example, no user input is required, and the data pipeline automatically labels those documents that have a relevancy score above a given threshold as productions. The relevancy score can be based, for example, on just the top X number of prioritized documents. In another example, the relevancy function of one or more of the priority ranking, the legal metric, and the classification of the document type. The production names and other related metadata are entered into the database 303. 1509, or 1511, or a combination thereof, as structured data.

In particular, for each production, the NLP outputs and classifications are used to pre-fill structured metadata entries (e.g. document name, document date, matter type identification, matter identification number, author name, etc.).

The data pipeline then extracts points from the productions. For each production, in an example aspect, the NLP model is re-run on the given production using a subset of the set of productions as a new statistical model. The data pipeline identifies and segments facts within the given production according to various attributes (e.g. type of legal assessment, production type, and production content) using a Statistical NLP model to classify and cluster. It will be appreciated that facts are considered a greater subset of information in the given production, and one, or some, or all of the facts are considered one or more points. It will also be appreciated that the same text in the given production can be used to generate multiple facts. The data pipeline then displays the facts to the user, and the user provides input to identify which one of the facts are considered a point.

The data pipeline then uses these identified points to automatically store the points and related metadata into the database 303, 1509, or 1511, or a combination thereof. For each point, the data pipeline uses the NLP outputs and classifications to pre-fill structured point metadata fields (e.g. point text, point location (within its source production), etc.). The data pipeline also automatically adds tags to augment the meaning of the data. In a further example aspect, data pipeline automatically sorts the data based on relevance.

In an example aspect, this outputted structured data is provided back to a cloud server platform to perform data science to gain additional legal insights (e.g. patterns, trends, anomalies, etc.). The data from the databases 303 or 1511, or both, can be centralized across many different use cases and different users, and analyzed to identify these additional legal insights.

Additional example embodiments and example aspects are described below.

In an example embodiment, a computing device is provided that includes memory that stores thereon a content editor application and a QDS system, the QDS system incorporated into the content editor application. The QDS system includes a presentation layer, a logic layer, and a database that stores structured data. The memory also includes a report file in the content editor application that is populated by the QDS system. The computing device further includes a processor that uses user input received via the presentation layer to populate the database with the structured data, wherein in the logic layer is configured to obtain at least a portion of the structured data from the database to populate the report file in the content editor.

In an example aspect, the processor initiates display of the report file and the presentation layer in a graphical user interface of the content editor application.

In another example aspect, the presentation layer and the report file are simultaneously displayed.

In another example aspect, the presentation layer and the report file are displayed at different times.

In another example aspect, the presentation layer is displayable in a web browser.

In another example aspect, the database comprises one or more files in a markup language readable by a web browser.

In another example aspect, the database comprises one or more XML files.

In another example aspect, the logic layer interfaces with the report file via one or more content editor application programming interfaces.

In another example aspect, a document file comprises one or more sub-files dedicated to the report file and one or more sub-files dedicated to the QDS system.

In another example aspect, the one or more sub-files dedicated to the QDS system form the database.

In another example aspect, the one or more sub-files dedicated to the report file and the one or more sub-files dedicated to the QDS system are data compressed to form the document file, having one of a positive, a zero, and a negative data compression ratio.

In another example aspect, the document file is a Microsoft Word file, and the one or more sub-files dedicated to the report file and the one or more sub-files dedicated to the QDS system are XML files.

In another example aspect, the memory further stores thereon a file system comprising one or more data files, and the structured data in the database comprises a data link to the one or more data files.

In another example aspect, the memory further stores thereon a file daemon that forms a data bridge between the QDS system and the file system for the QDS system to access the one or more data files.

In another example aspect, the file daemon comprises a local webserver and the QDS system, and wherein the file daemon and the QDS system communicate with each other using a web-based communication protocol.

In another example aspect, the one or more data files comprise unstructured data, and the structured data stored in the database is at least one of obtained and derived from the unstructured data.

In another example aspect, the report file is editable by a graphical user interface of the content editor.

In another example embodiment, a QDS system is provided that includes: a presentation layer, a logic layer and a database that stores structured data. The presentation layer includes a web browser graphical user interface that is integrated into a content editor application for at least one of displaying and receiving the structured data. The logic layer interacts with the presentation layer, the database, and a report file displayable by the content editor application. The database includes a set of sub-files that form a portion of a document file, and the document file further includes another set of sub-files that form the report file.

In an example aspect, the database includes a caching layer and a persistence layer. The persistence layer stores the set of sub-files of the database, and the database further includes an application programming interface for interacting with the content editor application.

In another example aspect, the database further includes a security layer that secures data transmitted between the persistence layer and the caching layer.

In another example aspect, new structured data received at the presentation layer is first stored in the persistence layer and then later stored in the caching layer.

In another example embodiment, a QDS system is provided that includes: a presentation layer, a logic layer and a database that only temporarily stores structured data. The presentation layer includes a web browser graphical user interface that is integrated into a content editor application for at least one of displaying and receiving the structured data. The logic layer interacts with the presentation layer, the database, and a report file displayable by the content editor application. The database includes one or more sub-files that form a portion of a document file, and the document file further includes another one or more sub-files that form the report file. After the QDS system obtains the structured data from an external database, the QDS system temporarily stores the structured data in the database for display in at least one of the presentation layer and the report file.

In an example aspect, the database includes a security layer and a caching layer that temporarily stores the structured data, and the security layer secures data transmitted between the external database and the caching layer.

In another example embodiment, a document file is provided that is editable by a content editor application. The document file includes: one or more sub-files dedicated to a report file that is editable in a graphical user interface of the content editor application and one or more sub-files dedicated to a QDS system; the one or more sub-files dedicated to the report file include a sub-file for a main body of the report file; the one or more sub-files dedicated to the QDS system include a database for structured data; and wherein the QDS system is an application in a web browser and the one or more sub-files dedicated to the QDS system are in a markup language readable by the web browser.

In an example aspect, the document file includes multiple sub-files dedicated to the QDS system, the multiple sub-files include: a first sub-file for a first type of structured data, and a second sub-file for a second type of structured data.

In another example aspect, the one or more sub-files dedicated to the report file and the one or more sub-files dedicated to the QDS system are all XML files.

In another example aspect, the document file is a Microsoft Word file.

In another example embodiment, a content editor application is provided that includes a document file that includes a report file that is displayable and editable using a graphical user interface of the content editor application. The content editor application also includes a QDS system that is a web browser add-in to the content editor application, and which includes: a presentation layer for at least one of receiving and modifying structured data, a logic layer that interacts with the report file, and a database for storing structured data. The report file and the presentation layer are displayed in the graphical user interface of the content editor application, and at least a portion of the structured data stored in the database is insertable into the report file by the logic layer.

In an example aspect, the content editor application further includes an application programming interface with which the QDS system uses to insert at least the portion of the structured data into the report file.

In another example aspect, the document file includes one or more sub-files dedicated to the report file and one or more sub-files dedicated to the QDS system; and the database includes the one or more sub-files dedicated to the QDS system to store the structured data.

In another example aspect, the one or more sub-files dedicated to the report file include a sub-file for a main body of the report file.

In another example aspect, the one or more sub-files dedicated to the report file and the one or more sub-files dedicated to the QDS system are all XML files.

In another example aspect, the database forms part of the document file.

In another example aspect, the content editor is a Microsoft Word application and the document file is a Microsoft Word file. Furthermore, one or more XML files form the database and are part of the document file.

In another example aspect, the database only temporarily stores the structured data in a caching layer in the database, and the QDS system obtains the structured data from a second database that is external to the content editor application.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, EEPROM, flash memory or other memory technology, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers or computing devices or nodes, or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. A computing device comprising:
memory that stores thereon a content editor application and a quick data structuring system, the quick data structuring system incorporated into the content editor application; the quick data structuring system comprising a presentation layer, a logic layer, and a database that stores structured data; and a report file in the content editor application that is populated by the quick data structuring system; and
a processor that uses user input received via the presentation layer to populate the database with the structured data, wherein in the logic layer is configured to obtain at least a portion of the structured data from the database to populate the report file in the content editor.

2. The computing device of claim 1 wherein the processor initiates display of the report file and the presentation layer in a graphical user interface of the content editor application.

3. The computing device of claim 2 wherein the presentation layer and the report file are simultaneously displayed.

4. The computing device of claim 2 wherein the presentation layer and the report file are displayed at different times.

5. The computing device of claim 1 wherein the presentation layer is displayable in a web browser.

6. The computing device of claim 1 wherein the database comprises one or more files in a markup language readable by a web browser.

7. The computing device of claim 1 wherein the database comprises one or more XML files.

8. The computing device of claim 1 wherein the logic layer interfaces with the report file via one or more content editor application programming interfaces.

9. The computing device of claim 1 wherein a document file comprises one or more sub-files dedicated to the report file and one or more sub-files dedicated to the quick data structuring system.

10. The computing device of claim 9 wherein the one or more sub-files dedicated to the quick data structuring system form the database.

11. The computing device of claim 9 wherein the one or more sub-files dedicated to the report file and the one or more sub-files dedicated to the quick data structuring system are data compressed to form the document file, having one of a positive, a zero, and a negative data compression ratio.

12. The computing device of claim 9 wherein the document file is a Microsoft Word file, and the one or more sub-files dedicated to the report file and the one or more sub-files dedicated to the quick data structuring system are XML files.

13. The computing device of claim 1 wherein the memory further stores thereon a file system comprising one or more data files, and the structured data in the database comprises a data link to the one or more data files.

14. The computing device of claim 13 wherein the memory further stores thereon a file daemon that forms a data bridge between the quick data structuring system and the file system for the quick data structuring system to access the one or more data files.

15. The computing device of claim 14 wherein the file daemon comprises a local webserver and the quick data structuring system, and wherein the file daemon and the quick data structuring system communicate with each other using a web-based communication protocol.

16. The computing device of claim 13 wherein the one or more data files comprise unstructured data, and the structured data stored in the database is at least one of obtained and derived from the unstructured data.

17. The computing device of claim 1 wherein the report file is editable by a graphical user interface of the content editor.

18. A quick data structuring system comprising:
a presentation layer, a logic layer and a database that stores structured data;
the presentation layer comprising a web browser graphical user interface that is integrated into a content editor application for at least one of displaying and receiving the structured data;
the logic layer interacts with the presentation layer, the database, and a report file displayable by the content editor application; and
the database comprising a set of sub-files that form a portion of a document file, and the document file further comprises another set of sub-files that form the report file.

19. The quick data structuring system of claim 18 wherein the database comprises a caching layer and a persistence layer, the persistence layer stores the set of sub-files of the database, and the database further comprises an application programming interface for interacting with the content editor application.

20. The quick data structuring system of claim 19 wherein the database further comprises a security layer that secures data transmitted between the persistence layer and the caching layer.

21. The quick data structuring system of claim 18 wherein new structured data received at the presentation layer is first stored in the persistence layer and then later stored in the caching layer.

22. A quick data structuring system comprising:
a presentation layer, a logic layer and a database that only temporarily stores structured data;
the presentation layer comprising a web browser graphical user interface that is integrated into a content editor application for at least one of displaying and receiving the structured data;
the logic layer interacts with the presentation layer, the database, and a report file displayable by the content editor application; and
the database comprising one or more sub-files that form a portion of a document file, and the document file further comprises another one or more sub-files that form the report file;
wherein, after the quick data structing system obtains the structured data from an external database, the quick data structuring system temporarily stores the structured data in the database for display in at least one of the presentation layer and the report file.

23. The quick data structuring system of claim 22 wherein the database comprises a security layer and a caching layer that temporarily stores the structured data, and the security layer secures data transmitted between the external database and the caching layer.

24. A content editor application comprising:
a document file that comprises a report file that is displayable and editable using a graphical user interface of the content editor application;
a quick data structuring system that is a web browser add-in to the content editor application, and which comprises: a presentation layer for at least one of receiving and modifying structured data, a logic layer that interacts with the report file, and a database for storing structured data; and
wherein the report file and the presentation layer are displayed in the graphical user interface of the content editor application, and at least a portion of the structured data stored in the database is insertable into the report file by the logic layer.

25. The content editor application of claim 24 further comprising an application programming interface with which the quick data structuring system uses to insert at least the portion of the structured data into the report file.

26. The content editor application of claim 24 wherein the document file comprises one or more sub-files dedicated to the report file and one or more sub-files dedicated to the quick data structuring system; and the database comprises the one or more sub-files dedicated to the quick data structuring system to store the structured data.

27. The content editor application of claim 26 wherein the one or more sub-files dedicated to the report file comprise a sub-file for a main body of the report file.

28. The content editor application of claim 26 wherein the one or more sub-files dedicated to the report file and the one or more sub-files dedicated to the quick data structuring system are all XML files.

29. The content editor application of claim 24 wherein the database forms part of the document file.

30. The content editor application of claim 24 being a Microsoft Word application and the document file being a Microsoft Word file; wherein one or more XML files form the database and are part of the document file.

31. The content editor application of claim 24 wherein the database only temporarily stores the structured data in a caching layer in the database, and the quick data structuring system obtains the structured data from a second database that is external to the content editor application.
